(19) United States
(12) Patent Application Publication
(10) Pub. No.: US 2017/0178264 A1
(43) Pub. Date: Jun. 22, 2017

(54) TRANSFER CREDIT EVALUATION SYSTEM AND METHOD

(71) Applicant: AMERICAN PUBLIC UNIVERSITY SYSTEMS, INC., Charles Town, WV (US)

(72) Inventors: Tracy COSKER, Herndon, VA (US); Jeremy SIMPSON, Alexandria, VA (US); Caroline SIMPSON, Alexandria, VA (US); Christine ROY, Reston, VA (US); Nasko SHISHKOV, Manassas, VA (US); Josh KUSICH, Bristow, VA (US); Jo PASSUT, Culpeper, VA (US); Dan TODARO, Warrenton, VA (US); Allyn SCOTT, Centreville, VA (US)

(21) Appl. No.: 15/128,898

(22) PCT Filed: Mar. 24, 2015
(86) PCT No.: PCT/US2015/022234

§ 371 Date: Sep. 23, 2016

Related U.S. Application Data
(60) Provisional application No. 61/970,064, filed on Mar. 25, 2014.

(51) Int. Cl. G06Q 50/20; H04L 29/06; G06Q 10/10

(52) U.S. Cl. CPC G06Q 50/205; G06Q 10/10; H04L 63/102

(57) ABSTRACT

A system and method for granting course credits by a first educational institution from a second educational institution. A processor at a first educational institution receives a transcript from a student and converts the transcript to a format that allows transcript data to be obtained and reviewed in an automated fashions based on criteria. Course identifying information is determined and compared by the processor to course identifying information stored in a datastore. The processor then determines what courses are eligible for transfer credit when the course identifying information in the transcript data matches at least in part course identifying information stored in the datastore. The processor may also post granted credits to a student's academic plan.

### RELATED APPLICATIONS

The present application claims the benefit or priority to U.S. Provisional Patent Application No. 61/970,064 entitled “Transfer Credit Evaluation System and Method” filed Mar. 25, 2014, the entire contents of which are hereby incorporated by reference.

### BACKGROUND

The phrase “educational institution” typically engenders images of a physical place, perhaps with a tree-lined campus, student dormitories, and a faculty member lecturing before a classroom of students. The Internet has spawned another kind of educational institution, one with a virtual classroom in which students interact with a teacher via a computer. While brick and mortar facilities have not been replaced, the Internet has brought the content of the classroom to the home and office.

While a network-based distance-learning environment (sometimes referred to as, a “virtual university”) leverages new technologies to improve the accessibility of educational opportunities, the virtual university must deal with many of the administrative challenges faced by brick and mortar institutions. For example, many of the students who attend a virtual university seek to receive credit for courses taken at other universities. Students may also request credit for non-academic experiences such as on the job training, military training and life experiences.

Providing credits for courses taken at other universities is typically a manual process that involves obtaining evidence of completion of the prior courses (for example, receiving a transcript from the other university), assessing the equivalency of the previous course to a course offered by the virtual university, determining whether a credit can be granted, determining a magnitude of the credit, and applying the credit to the student's program of study (sometimes referred to herein as an “academic plan”). In order to obtain the transcript, another manual process is used to obtain the student's authorization and to convey the authorization to the other university. A student request for credits is handled individually and is, therefore, resource intensive, time consuming and susceptible to errors. The assessment of the equivalency of the previous course to a course offered by the virtual university, determining whether a credit can be granted, determining a magnitude of the credit, and applying the credit to the student's program of study is a labor intensive and error prone manual process.

Credit for non-academic experiences are generally evaluated on a situation-by-situation basis.

### SUMMARY

Embodiments herein are directed to systems and methods for obtaining authorization by an admitting university from a student to request a transcript and/or test scores and for evaluating a student transcript to determine the eligibility of courses taken at other universities for credits toward a degree program offered by the admitting university. Embodiments are also directed to systems and methods for evaluating by an admitting university non-academic experiences and determine the eligibility of training courses taken by a student or perspective student for credits toward a degree program offered by the admitting university. Embodiments are also directed to posting granted credits to a student's academic plan.

### DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a flow diagram illustrating a process by which a university may grant credits for courses taken by a student from another educational institution according to an embodiment.

FIG. 2 is a flow diagram illustrating a transcript release authorization process according to an embodiment.

FIG. 3 is a flow diagram illustrating a transcript data acquisition process according to an embodiment.

FIG. 4 is a flow diagram illustrating a transfer credit evaluation process according to an embodiment.

FIG. 5A is a flow diagram illustrating a test score data acquisition process according to an embodiment.

FIG. 5B is a flow diagram illustrating a military transcript data acquisition process according to an embodiment.

FIG. 6A is a flow diagram illustrating a test score credit evaluation process according to an embodiment.

FIG. 6B is a flow diagram illustrating a military transcript credit evaluation process according to an embodiment.

FIGS. 7A and 7B are flow diagrams illustrating a credit posting process for posting granted credits to a student's academic plan according to an embodiment.

FIG. 8 is a block diagram illustrating functional components of a personal computer.

FIG. 9 is a block diagram illustrating functional components of a server.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The following applications are incorporated by reference in their entireties for all purposes: U.S. application Ser. No. 13/013,922, filed Jan. 26, 2011 and U.S. patent application Ser. No. 11/032,587 filed Jan. 10, 2005. Without limiting the present application, subject matter from various drawings of the 12/013,922 application and the 11/032,587 application, and discussions of those drawings, is incorporated herein and may be referenced in the claims.

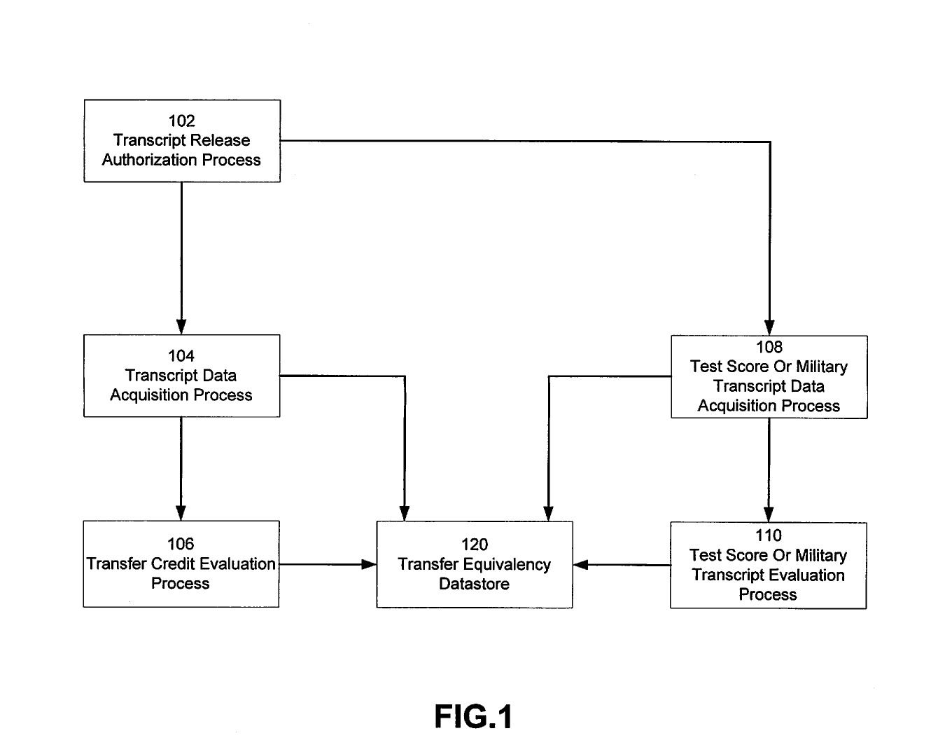

FIG. 1 is a high level flow diagram illustrating a process by which transcripts may be acquired by a university, data may be extracted from the acquired transcripts, and the extracted data may be evaluated to determine whether the data describes a course for which the university will grant credit. In an embodiment, the operations of the processes illustrated in FIG. 1 may be performed by a processor of a computing device, such as a personal computer or server. A transcript release authorization process (Block 102) may be initiated by a student or perspective student and provides the admitting university permission (e.g., the first educational institution) to request a transcript from an educational institution attended by the student (e.g., the second educational institution). The received transcript may then be processed (Block 104) to extract transcript data. Transcript data comprises course identifying information (or data) such as, but without limitation, course name, course prefix, course number, course title, date completed, grade earned, hours earned, date taken (e.g., semester/quarter), and other information that identifies the course(s) taken. The extracted data may then be used to determine whether the student is entitled to credits for courses taken at the educational institution from which the transcript originated (Block 106).

In an embodiment, the transcript release authorization may include a release of test results or the release of a military transcript. The received test result or military transcript may then be processed (Block 108) to extract test score data. The extracted data may then be used to determine whether the student may be entitled to credits for courses taken at the educational institution from which the transcript originated and/or for credits in relation to military service (Block 110). In an embodiment, the determination whether a student may be entitled to credits for courses taken or based on test scores or military transcripts may be made by referencing a transfer equivalency datastore (Block 120).

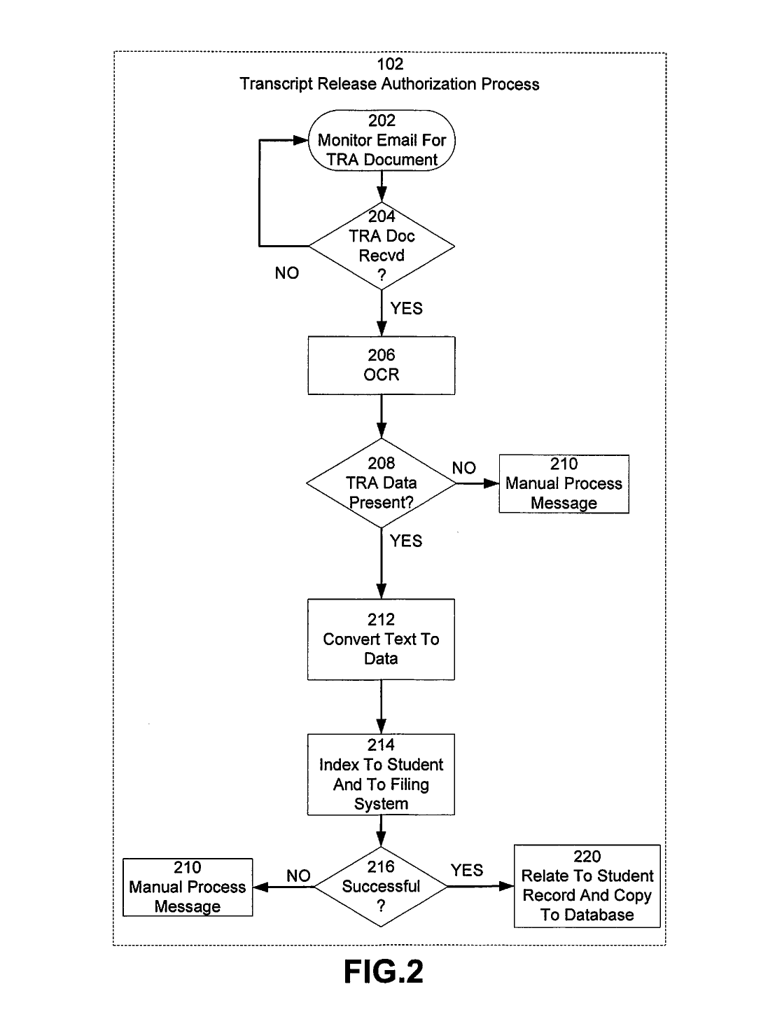

FIG. 2 is a flow diagram illustrating a transcript release authorization process 102 according to an embodiment. In an embodiment, the operations of the transcript release authorization process 102 may be performed by a processor of a computing device, such as a personal computer or server.

In an embodiment, an admitting university monitors an email server for incoming emails that include transcript release authorization (TRA) documents (Block 202). In another embodiment, an admitting university may receive hard copy TRA documents and scan the TRA documents and store the digitized TRA documents. In an embodiment, the admitting university provides a transcript release form for completion by students. The form may be emailed to the admitting university by the student or perspective student and detected during the monitoring process. In an embodiment, TRA documents are sent to a specific email address and only the specified email address is monitored.

In an embodiment, a determination is made at Block 204 whether a whether a TRA document has been received. A TRA document may received in various formats, including a portable document format, a tagged image file format, a bit map format, or a Joint Photographic Experts Group format. If a TRA document has not been received, that is, if the result of Block 204 is “NO,” the process returns to monitoring at Block 202. If a TRA document has been received, that is, if the result of Block 204 is “YES,” the TRA document is subjected to optical character recognition (OCR) (Block 206).

A determination is made whether TRA data is present in text a document generated by the OCR process at Block 208. By way of illustration and not by way of limitation, the text document may be evaluated to determine whether data elements required for a valid TRA document can be found. The lack of such data elements may indicate that the TRA document is in an unknown format, is corrupted, or is not actually a TRA document.

If the required data elements cannot be found in the text document, that is, if the result of Block 208 is “NO,” a record is made of the failure of that student's transcript and a message is sent to appropriate staff indicating that the TRA document must be manually reviewed (Block 210). If the required data elements can be found in the text document, that is, if the result of Block 208 is “YES,” the text document is parsed and data is extracted (Block 212). In this manner, text may be converted to data. The extracted data may be saved in a formatted data file, such as, for example, and Extensible Markup Language Format (XML) file.

The formatted data file may be indexed to a student record and sent to a database (Block 214). A determination is made whether if the indexing process is successful in Block 216. If the indexing process is not successful, that is, if the result of Block 216 is “NO,” a record is made of the failure of that student's transcript and a message is sent to appropriate staff that the TRA document must be manually reviewed (Block 210). If the indexing process is successful, that is, if the result of Block 216 is “YES,” a record of the student to which the transcript pertains is updated to indicate receipt of the transcript and a copy or image of the transcript is saved to a database 220.

In an embodiment, the indexing process updates the student's document log with a received date. An email reporting the receipt of the authorization may be automatically generated and sent to the student.

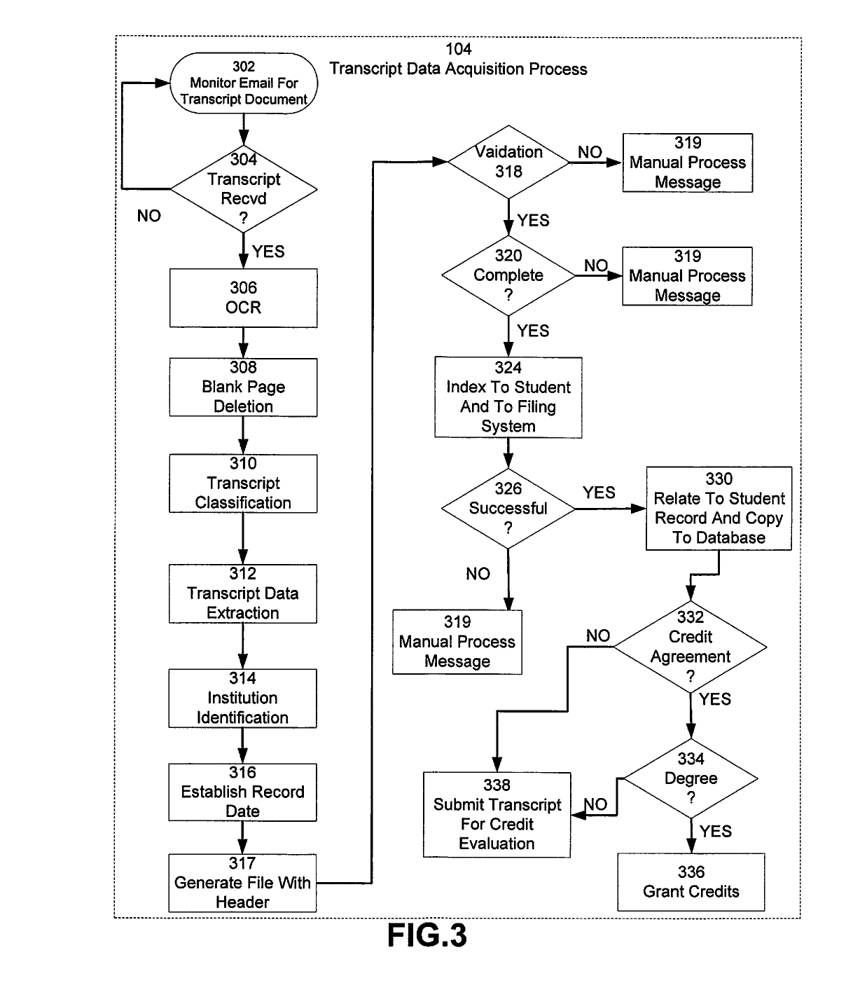

FIG. 3 is a flow diagram illustrating a transcript data acquisition process 104 according to an embodiment. In an embodiment, the operations of the transcript data acquisition process 104 may be performed by a processor of a computing device, such as a personal computer or server.

In an embodiment, an admitting university monitors an email server for incoming emails that include transcript documents (Block 302.) In an embodiment, transcript documents are sent to a specific email address and only the specified email address is monitored.

In an embodiment, a determination is made at Block 304 whether a whether a transcript document has been received. If a transcript document has not been received, that is, if the result of Block 304 is “NO,” the process returns to monitoring at Block 302. If a transcript document has been received, that is, if the result of Block 304 is “YES,” the transcript document is subjected to optical character recognition (OCR) if it is in electronic form. Alternatively, if the transcript document is not received via e-mail, it may be scanned and subjected to OCR if received in hard copy form (Block 306).

The text document generated by the OCR process (Block 306) may be evaluated using a series of filters.

At Block 308, the resulting text document is evaluated to determine whether the back pages of the transcript are blank or contain additional information. Blank pages are deleted. Back pages that contain additional information are compared to determine whether the information is the same. When the information is the same, only one copy of the information is saved.

At Block 310, the resulting text document is evaluated to classify the transcript based on its physical layout. For example, the transcript may be oriented in portrait or landscape mode, the data may be in one or more columns, and the data may be contained with a defined space (e.g., a text box) or distributed across a page.

At Block 312, data from the transcript is extracted. The extraction process captures both information that facilitates indexing the transcript (for example, the educational institution from which the transcript originated, the name of the student to whom it pertains, etc.) and whether a degree, such as an associate or bachelor's degree, was conferred.

At Block 314, the institution from which the transcript was received is identified. In an embodiment, institutions from which transcripts are frequently requested are identified. Transcripts from these universities may be processed in a particular way because the format of the transcript has been learned and stored. The classifying process may be used to apply extraction rules that are specific to a particular university.

At Block 316, the date from the transcript is extracted and used to establish a record date.

At Block 317, a transcript file is generated from the extracted data. The transcript file includes a header that includes information that facilitates indexing the transcript (for example, the educational institution from which the transcript originated, the course semester, the course prefix, the course number, the course name, the date completed, the name of the student to whom it pertains, the student's first name, last name, address, an identifier such as a portion of the student's social security number, date of birth) and the transcript data (for example, credit hours and grades).

At Block 318, the data from the transcript is validated. If validation is successful (i.e., Block 318=“Yes”), the information is passed on to determine if the validated information is complete (Block 320). If validation of data cannot be accomplished (i.e., Block 318=“No”), a record is made of the failure of that student's transcript and a message is sent to appropriate staff that the transcript document must be manually reviewed (Block 319).

In an embodiment, a determination is made at Block 320 whether the header information is complete and accurate. If the header information in incomplete or inaccurate, that is, if the result of Block 320 is “NO,” a record is made of the failure of that student's transcript and a message is sent to appropriate staff that the TRA document must be manually reviewed as discussed above (Block 319). If the header information in complete and accurate, that is, if the result of Block 320 is “YES,” the transcript document is indexed (Block 324).

A determination is made whether if the indexing process is successful (Block 326). If the indexing process is not successful, that is, if the result of Block 326 is “NO,” a record is made of the failure of that student's transcript and a message is sent to appropriate staff that the transcript document must be manually reviewed (Block 319). If the indexing process is successful, that is, if the result of Block 326 is “YES,” a record of the student to which the transcript pertains is updated to indicate receipt of the transcript and a copy or image of the transcript is saved to a database (Block 330). In an embodiment, an email may be automatically generated and sent to inform the student that the transcript has been received and is being processed.

In an embodiment, a determination is made whether the transcript is from an educational institution with which the admitting university has an established transfer credit agreement (Block 332). The determination may be made by reference to transfer equivalency datastore 120 (see, FIG. 1). If the transcript is from an educational institution with which the admitting university has an established transfer credit agreement, that is, if the result of Block 332 is “YES,” a determination is made whether the student was granted a degree (Block 334). If the student was granted a degree by the educational institution subject to the transfer credit agreement, that is, if the result of Block 334 is “YES,” the student is granted transfer credits according to the terms of the transfer credit agreement (Block 336). If the transcript is not from an educational institution with which the admitting university has an established transfer credit agreement, that is, if the result of Block 332 is “NO,” or if the student was not granted a degree by the educational institution subject to the transfer credit agreement, that is, if the result of Block 334 is “NO,” the transcript is submitted for credit evaluation processing (Block 336).

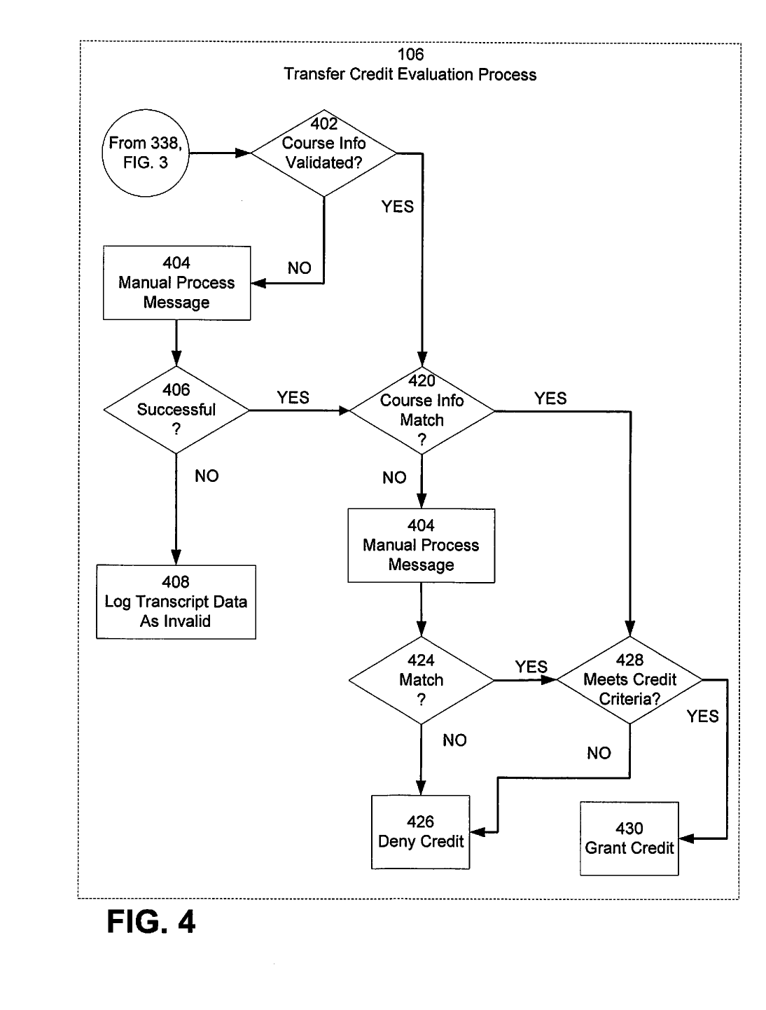

FIG. 4 is a flow diagram illustrating a transfer credit evaluation process 106 according to an embodiment. In an embodiment, the operations of the transfer credit evaluation process 106 may be performed by a processor of a computing device, such as a personal computer or server.

After successful indexing and determining that the transcript is not from an educational institution with which the admitting university has an established transfer credit agreement or the student was not granted a degree by the educational institution subject to the transfer credit agreement, the course information captured in the transcript data may be validated (Block 402). A determination is made at Block 402 whether the course information is valid. If the course information is not valid, that is, if the result of Block 402 is “NO,” a record is made of the failure of the validation process and a message is sent to appropriate staff for manual correction (Block 404). A determination is made at Block 406 whether the manual correction of the course information was successful. If the course information cannot be corrected manually, that is, if the result of Block 406 is “NO,” the course information is flagged as invalid (Block 408).

If the course information is determined to be valid, that is, if the result of Block 402 is “YES” or the result of Block 406 is “YES,” a determination is made whether the course information matches course information stored in a datastore (Block 420), such as, for example, datastore 120 (see, FIG. 1). Course information may include course identifying information (or data) such as, but without limitation, course name, course prefix, course number, course title, date completed, grade earned, hours earned, date taken (e.g., semester/quarter), and other information that identifies the course(s) taken, a course level indication (e.g., graduate, undergraduate, etc.) etc. The datastore may include entries related to a number of institutions, for example over a thousand institutions, such as 1,000 institutions or more, 2000 institutions or more, 3,000 intuitions or more, 3,809 institutions or more, etc. Additionally, the datastore may include entries related to a number of courses for which credit may be granted, such as greater than ten thousand courses, such as 10,000 courses or more, 100,000 courses or more, 300,000 courses or more, 347,000 courses or more, etc. In block 406 the course information may be compared to the course information for every institution and course listed in the datastore, for example the determined valid course information may be compared against 347,000 courses or more to determine a match between the course information and course information in the datastore.

If the course information from the transcript matches course information in the datastore, that is, if the result of Block 420 is “YES,” the transcript data are evaluated against credit criteria to determine whether a credit may be granted for the course (Block 428). The credit criteria may also be stored in a datastore, such as, for example, datastore 120 (see, FIG. 1). Transcript data may be evaluated against credit criteria to determine whether a credit may be granted for the course using a rules engine that applies a series of rules for credit criteria to the course information determined to be valid and matching course information in the datastore. For example, rules may govern the credit criteria that allow the course from the prior institution to granted credit. The rules may be stored in various formats, including as series of rules statements in code defining the rules engine. The rules engine may apply a series of one or more rules sequentially to the transcript data to determine whether or not the transcript data meets the credit criteria.

If the transcript data meet the credit criteria, that is, if the result of Block 428 is “YES,” the student is granted credit for the course (Block 430). If the transcript data do not meet the credit criteria, that is, if the result of Block 428 is “NO,” the student is denied credit for the course (Block 426).

In an embodiment, the credit criteria may include a grade for the course. In certain instances a grade point average is a valuable credential for a graduate of an educational institution. Where this is the case, the various embodiments illustrated herein may account for the grade received by the individual when that individual completed the course at a prior institution. So long as the admitting university has an agreement with the prior educational institution, the admitting university can use the grade received by the student together with the credit for the course that is transferred to be applied to that student's educational record. In so doing, a grade point average that is inclusive of the transfer credits can be generated. Additionally, credit criteria may include a requirement that the prior institution was accredited at the time the course was taken by the student at the prior institution. As another example, credit criteria may include a requirement that the course was taken within a set time period from the date when the request for credit is made.

If the course information from the transcript does not match course information in the datastore, that is, if the result of Block 420 is “NO,” a record is made of the failure of that student's transcript and a message is generated to appropriate staff that the course information must be manually reviewed (Block 404). If the course equivalent is not automatically matched by the database, an Evaluator considers all or some of the following: course prefix, course number, course title (this is looked at to ensure that the database info is extended for any partial matches that come through), date completed, etc. to determine if some course equivalency exists. If the info is not in the database at all, the evaluator reviews key words and learning outcomes in a course description/syllabus to again determine course equivalency. The system, at Block 424 receives a message including results of a review as noted above. A determination is then made at Block 424 whether the manual evaluation results in a match in the datastore. If no match is found, that is, if the result of Block 424 is “NO,” the request for credit is denied (Block 426). If a match is found, that is, if the result of Block 424 is “YES,” the transcript data are evaluated against credit criteria to determine whether a credit may be granted for the course (Block 428). If the transcript data meet the credit criteria, that is, if the result of Block 428 is “YES,” the student is granted credit for the course (Block 430). If the transcript data do not meet the credit criteria, that is, if the result of Block 428 is “NO,” the student is denied credit for the course (Block 426).

In an embodiment, courses that were not found in the datastore 120 but were determined to be entitled to credit may be added to the datastore 120.

In an embodiment, non-traditional test scores may be evaluated for possible course credit. By way of illustration and not by way of limitation, a non-traditional test score may be extracted from a DSST Exam Document, a CLEP Exam Document, a Defense Language Proficiency Test Score Report, and an AP Exam Document.

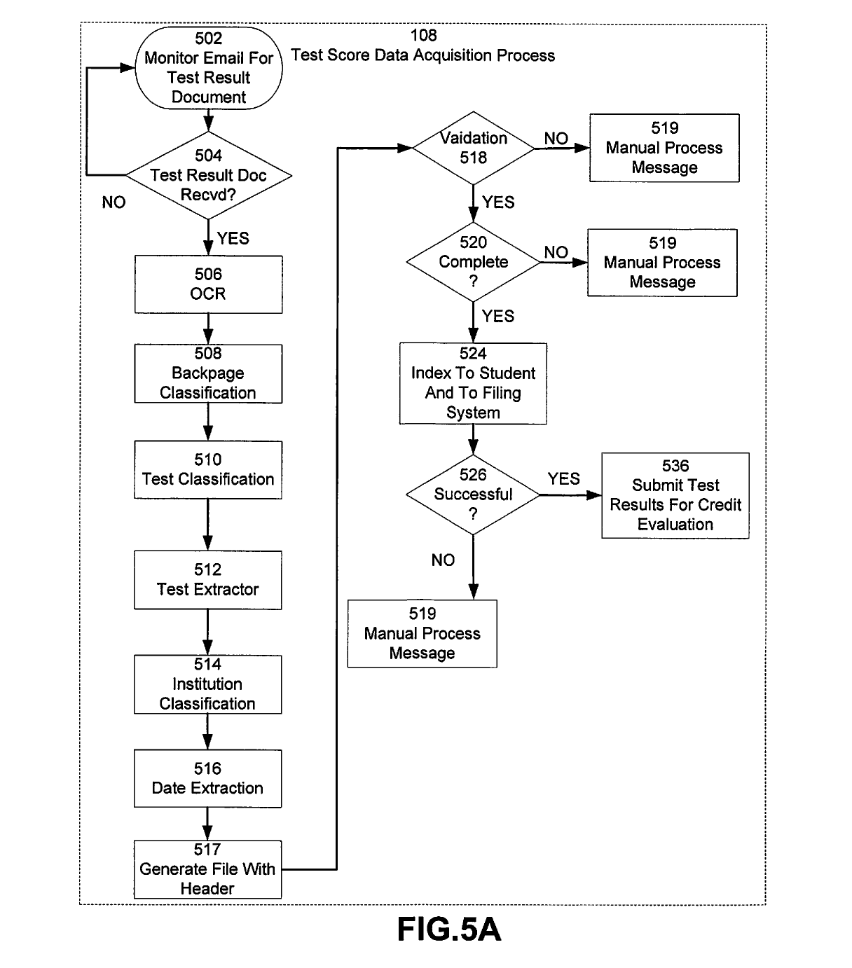

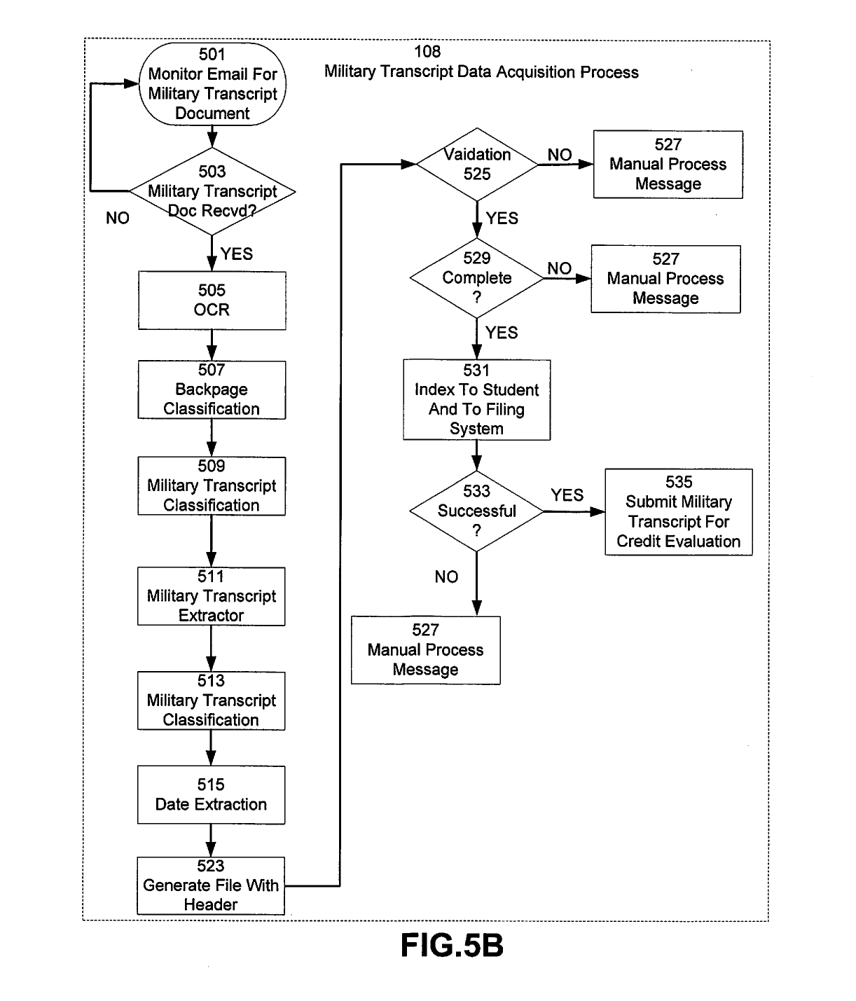

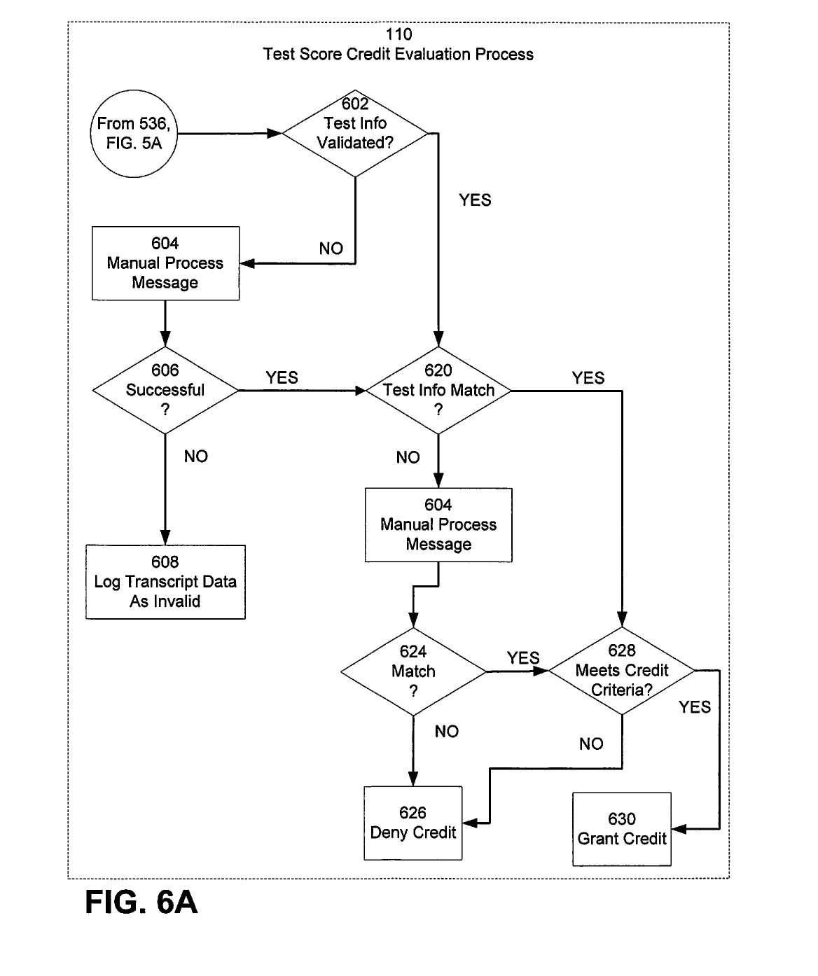

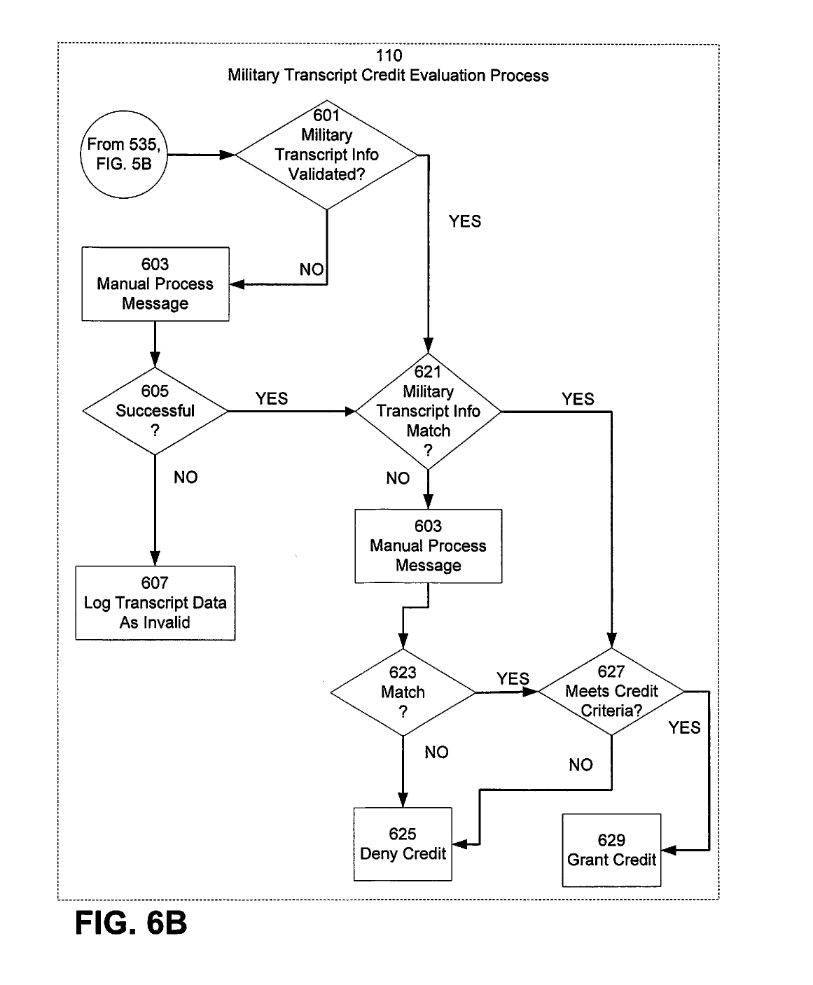

FIG. 5A is a flow diagram illustrating a test data acquisition process 108 according to an embodiment. In an embodiment, the operations of the test data acquisition process 108 may be performed by a processor of a computing device, such as a personal computer or server.

In an embodiment, an admitting university monitors an email server for incoming emails that include test result documents (Block 502). In an embodiment, test result documents are sent to a specific email address and only the specified email address is monitored.

In an embodiment, a determination is made at Block 504 whether a whether a test result document has been received. If a test result document has not been received, that is, if the result of Block 504 is “NO,” the process returns to monitoring at Block 502. If a test result document has been received, that is, if the result of Block 504 is “YES,” the test result document is subjected to optical character recognition (OCR) (Block 506).

The text document generated by the OCR process (Block 506) is evaluated using a series of filters.

At Block 508, the resulting text document is evaluated to determine whether the back pages of the test result are blank or contain additional information. Blank pages are deleted. Back pages that contain additional information are compared to determine whether the information is the same. When the information is the same, only one copy of the information is saved.

At Block 510, the resulting text document is evaluated to classify the test result based on its physical layout. For example, the test result may be oriented in portrait or landscape mode, the data may be in one or more columns, and the data may be contained with a defined space (e.g., a text box) or distributed across a page.

At Block 512, data from the test result is extracted. The extraction process captures both information that facilitates indexing the test result (for example, the educational institution from which the test result originated, the name of the student to whom it pertains) and whether a degree, such as an associate or bachelor's degree, was conferred.

At Block 514, the institution from which the test result was received is classified. In an embodiment, institutions from which test results are frequently requested are identified. Test results from these universities may be processed in a particular way because the format of the test result has been learned and stored. The classifying process may be used to apply extraction rules that specific to a particular university.

At Block 516, the date from the test result is extracted and used to establish a record date.

At Block 517, a test result file is generated from the extracted data. The test result file includes a header that includes information that facilitates indexing the test result (for example, the educational institution from which the test result originated, the name of the student to whom it pertains, the student's address, an identifier such as a portion of the student's social security number,) and the test result data (for example, test score).

At Block 518, the data from the test result is validated. If validation is successful, the information is passed on to determine if the validate information is complete (Block 520). If validation of data cannot be accomplished, a record is made of the failure of that student's test result and a message is sent to appropriate staff that the test result document must be manually reviewed (Block 519).

In an embodiment, a determination is made at Block 520 whether the header information is complete and accurate. If the header information in incomplete or inaccurate, that is, if the result of Block 520 is “NO,” a record is made of the failure of that student's test result and a message is sent to appropriate staff that the test result document must be manually reviewed (Block 519). If the header information in complete and accurate, that is, if the result of Block 520 is “YES,” the test result document is indexed (Block 524).

A determination is made whether if the indexing process is successful (Block 526). If the indexing process is not successful, that is, if the result of Block 526 is “NO,” a record is made of the failure of that student's test result and a message is sent to appropriate staff that the test result document must be manually reviewed (Block 519). If the indexing process is successful, that is, if the result of Block 526 is “YES,” a record of the student to which the test result pertains is updated to indicate receipt of the test result and a copy or image of the test result is saved to a database (Block 530). In an embodiment, an email may be automatically generated and sent to inform the student that the test result has been received and is being processed.

In an embodiment military transcripts may be evaluated for possible course credit. By way of illustration and not by way of limitation, military transcripts may be provided by military or other governmental organizations (e.g., Army, Navy, Air Force, Coast Guard, National Guard, reserves, military academies, and training commands within such organization), and may include indications of courses taken during military service, experience gained during military service, and/or test scores from tests taken during military service. As examples, military transcripts may be extracted from the Joint Services Transcript (JST) portal, the Army/American Council on Education Registry Transcript System (AARTS), Sailor/Marine American Council on Education Registry Transcript System (SMARTS), or Coast Guard Institute (CGI) portal.

FIG. 5B is a flow diagram illustrating a military transcript data acquisition process 108 according to an embodiment. In an embodiment, the operations of the military transcript data acquisition process 108 may be performed by a processor of a computing device, such as a personal computer or server.

In an embodiment, an admitting university monitors an email server for incoming emails that include military transcript documents (Block 501). In an embodiment, military transcript documents are sent to a specific email address and only the specified email address is monitored. Another method for accessing military transcript documents is to upload the documents from a military website (e.g., JST) with permission of the student.

In an embodiment, a determination is made at Block 503 whether a whether a military transcript document has been received. If a military transcript document has not been received, that is, if the result of Block 503 is “NO,” the process returns to monitoring at Block 501. If a military transcript document has been received, that is, if the result of Block 503 is “YES,” the military transcript document is subjected to optical character recognition (OCR) (Block 505).

The text document generated by the OCR process (Block 505) is evaluated using a series of filters.

At Block 507, the resulting text document is evaluated to determine whether the back pages of the military transcript document are blank or contain additional information. Blank pages are deleted. Back pages that contain additional information are compared to determine whether the information is the same. When the information is the same, only one copy of the information is saved.

At Block 509, the resulting text document is evaluated to classify the military transcript based on its physical layout. For example, the military transcript may be oriented in portrait or landscape mode, the data may be in one or more columns, and the data may be contained with a defined space (e.g., a text box) or distributed across a page.

At Block 511, data from the military transcript is extracted. The extraction process captures both information that facilitates indexing the military transcript (for example, the military transcript type, the name of the student to whom it pertains).

At Block 513, the military transcript type is classified. In an embodiment, military transcript types which are frequently requested are identified. Military transcript for these military transcript types may be processed in a particular way because the format of the military transcript has been learned and stored. The classifying process may be used to apply extraction rules that specific to a particular military transcript type.

At Block 515, the date from the military transcript is extracted and used to establish a record date.

At Block 523, a military transcript file is generated from the extracted data. The military transcript file includes a header that includes information that facilitates indexing the military transcript (for example, the military transcript type, the name of the student to whom it pertains, the student's address, an identifier such as a portion of the student's social security number,) and the military transcript data (for example, military courses, military experience, test scores, etc.).

At Block 525, the data from the military transcript is validated. If validation is successful, the information is passed on to determine if the validate information is complete (Block 529). If validation of data cannot be accomplished, a record is made of the failure of that student's military transcript and a message is sent to appropriate staff that the military transcript document must be manually reviewed (Block 527).

In an embodiment, a determination is made at Block 529 whether the header information is complete and accurate. If the header information in incomplete or inaccurate, that is, if the result of Block 529 is “NO,” a record is made of the failure of that student's military transcript and a message is sent to appropriate staff that the military transcript document must be manually reviewed (Block 527). If the header information in complete and accurate, that is, if the result of Block 529 is “YES,” the military transcript document is indexed (Block 531).

A determination is made at Block 533 whether the indexing process is successful. If the indexing process is not successful, that is, if the result of Block 533 is “NO,” a record is made of the failure of that student's military transcript and a message is sent to appropriate staff that the military transcript document must be manually reviewed (Block 527). If the indexing process is successful, that is, if the result of Block 533 is “YES,” a record of the student to which the military transcript pertains is updated to indicate receipt of the military transcript and a copy or image of the military transcript is saved to a database (Block 535). In an embodiment, an email may be automatically generated and sent to inform the student that the military transcript has been received and is being processed.

FIG. 6A is a flow diagram illustrating a transfer credit evaluation process 110 according to an embodiment. In an embodiment, the operations of the test score credit evaluation process 110 may be performed by a processor of a computing device, such as a personal computer or server.

After successful indexing, the test result information captured in the test result data is validated (Block 602). A determination is made at Block 602 whether the test result information is valid. If the test result information is not valid, that is, if the result of Block 602 is “NO,” a record is made of the failure of the validation process and a message is generated to appropriate staff for manual correction (Block 604). A determination is made at Block 606 whether the manual correction of the test result information is successful. If the test result information cannot be corrected manually, that is, if the result of Block 606 is “NO,” the test result information is flagged as invalid (Block 608).

If the test result information is determined to be valid, that is, if the result of Block 602 is “YES,” or if the test result information is corrected successfully manually (i.e., Block 606 =“Yes”), a determination is made whether the test result information matches test result information stored in a datastore (Block 620), such as datastore 120 (see, FIG. 1). Test result information may include test identifying information (or data) such as, but without limitation, test or exam name, test prefix, date completed, grade or score earned, etc. The datastore may include entries related to a number of tests, for example over one hundred tests, such as 100 tests or more, 200 tests or more, 300 tests or more, 400 tests or more, 426 tests or more, etc. In block 620 the test result information may be compared to test result information listed in the datastore, for example the determined valid test result information may be compared against 426 tests or more to determine a match between the test result information and test result information in the datastore.

If the test result information from the test result document matches test result information in the datastore, that is, if the result of Block 620 is “YES,” the test result data are evaluated against credit criteria to determine whether a credit may be granted based on the test results (Block 628). The credit criteria may also be stored in a datastore, such as, for example, datastore 120 (see, FIG. 1). Test result data may be evaluated against credit criteria to determine whether a credit may be granted for the course using a rules engine that applies a series of rules for credit criteria to the test result information determined to be valid and matching test result information in the datastore. For example, rules may govern the credit criteria that allow the prior test result to be granted credit. The rules may be stored in various formats, including as series of rules statements in code defining the rules engine. The rules engine may apply a series of one or more rules sequentially to the test result data to determine whether or not the test result data meets the credit criteria.

If the test result data meet the credit criteria, that is, if the result of Block 628 is “YES,” the student is granted credit based on the test results (Block 630). If the test result data do not meet the credit criteria, that is, if the result of Block 628 is “NO,” the student is denied credit for the course (Block 626).

In an embodiment, the credit criteria may include a test score threshold above which credit is granted and test score data within the test result data may be compared to the test score threshold to determine whether to grant credit or deny credit to the student.

If the test result information from the test result document does not match test result information in the datastore, that is, if the result of Block 620 is “NO,” a record is made of the failure of that student's transcript and a message is generated to appropriate staff that the course information must be manually reviewed (Block 604). A determination is made at Block 624 whether the manual evaluation results in a match in the datastore or if the test result data is otherwise entitled to credit. If no match is found, that is, if the result of Block 624 is “NO,” the request for credit is denied (Block 626). If a match is found, that is, if the result of Block 624 is “YES,” the test result data are evaluated against credit criteria to determine whether a credit may be granted based on the test results (Block 628). If the test result data meet the credit criteria, that is, if the result of Block 628 is “YES,” the student is granted credit based on the test results (Block 630). If the test result data do not meet the credit criteria, that is, if the result of Block 628 is “NO,” the student is denied credit for the course (Block 626).

In an embodiment, tests that were not found in the datastore 120 but were determined to be entitled to credit are added to the datastore 120.

FIG. 6B is a flow diagram illustrating a transfer credit evaluation process 110 according to an embodiment. In an embodiment, the operations of the military transcript credit evaluation process 110 may be performed by a processor of a computing device, such as a personal computer or server.

After successful indexing, the military transcript information captured in the military transcript data is validated (Block 601). A determination is made at Block 601 whether the military transcript information is valid. If the military transcript information is not valid, that is, if the result of Block 601 is “NO,” a record is made of the failure of the validation process and a message is generated to appropriate staff for manual correction (Block 603). A determination is made at Block 605 whether the manual correction of the military transcript information is successful. If the military transcript information cannot be corrected manually, that is, if the result of Block 605 is “NO,” the military transcript information is flagged as invalid (Block 607).

If the military transcript information is determined to be valid, that is, if the result of Block 601 is “YES,” or if the military transcript information is corrected successfully manually (i.e., Block 605=“Yes”), a determination is made at Block 621 whether the military transcript information matches military transcript information stored in a datastore, such as datastore 120 (see, FIG. 1). Military transcript information may include military course and/or training identifying information (or data) such as, but without limitation, military course name, American Council of Education (ACE) identifier, military course identifier, date completed, grade or score earned, occupational specialty identifier, etc. The datastore may include entries related to a number of military course identifiers or ACE identifiers, for example over one thousand military course identifiers or ACE identifiers, such as 1000 military course identifiers or ACE identifiers or more, 4000 military course identifiers or ACE identifiers or more, 10,000 military course identifiers or ACE identifiers or more, 10,580 military course identifiers or ACE identifiers or more 50,000 military course identifiers or ACE identifiers or more, 61,310 military course identifiers or ACE identifiers or more, etc. In block 621 the military transcript information may be compared to military transcript information listed in the datastore, for example the determined valid military transcript information may be compared against 10,580 military course identifiers or ACE identifiers or more to determine a match between the military transcript information and military transcript information in the datastore.

If the military transcript information from the military transcript document matches military transcript information in the datastore, that is, if the result of Block 621 is “YES,” the military transcript data are evaluated against credit criteria to determine whether a credit may be granted, for example based on the American Council on Education (ACE) Credit results (Block 627). The credit criteria may also be stored in a datastore, such as datastore 120 (see, FIG. 1), for example. Military transcript data may be evaluated against credit criteria to determine whether a credit may be granted for the military course or training using a rules engine that applies a series of rules for credit criteria to the military transcript information determined to be valid and matching military transcript information in the datastore. For example, rules may govern the credit criteria that allow the military transcript information to be granted credit. The rules may be stored in various formats, including as series of rules statements in code defining the rules engine. The rules engine may apply a series of one or more rules sequentially to the military transcript data to determine whether or not the military transcript data meets the credit criteria.

If the military transcript data meet the credit criteria, that is, if the result of Block 627 is “YES,” the student is granted credit based on the military transcript (Block 629). If the military transcript data do not meet the credit criteria, that is, if the result of Block 627 is “NO,” the student is denied credit for the course (Block 625).

In an embodiment, the credit criteria may include a recommended credit threshold above which credit is granted and recommended credit data within the military transcript data may be compared to the recommended credit threshold to determine whether to grant credit or deny credit to the student.

If the military transcript information from the military transcript document does not match military transcript information in the datastore, that is, if the result of Block 621 is “NO,” a record is made of the failure of that student's transcript and a message is generated to appropriate staff that the course information must be manually reviewed (Block 603). A determination is made at Block 623 whether the manual evaluation results in a match in the datastore or if the military transcript data is otherwise entitled to credit. If no match is found, that is, if the result of Block 623 is “NO,” the request for credit is denied (Block 625). If a match is found, that is, if the result of Block 623 is “YES,” the military transcript data are evaluated against credit criteria to determine whether a credit may be granted based on the recommended credit (Block 627). If the military transcript data meet the credit criteria, that is, if the result of Block 627 is “YES,” the student is granted credit based on the comparison results (Block 629). If the military transcript data does not meet the credit criteria, that is, if the result of Block 627 is “NO,” the student is denied credit (Block 625).

In an embodiment, military transcript data that were not found in the datastore 120 but were determined to be entitled to credit are added to the datastore 120.

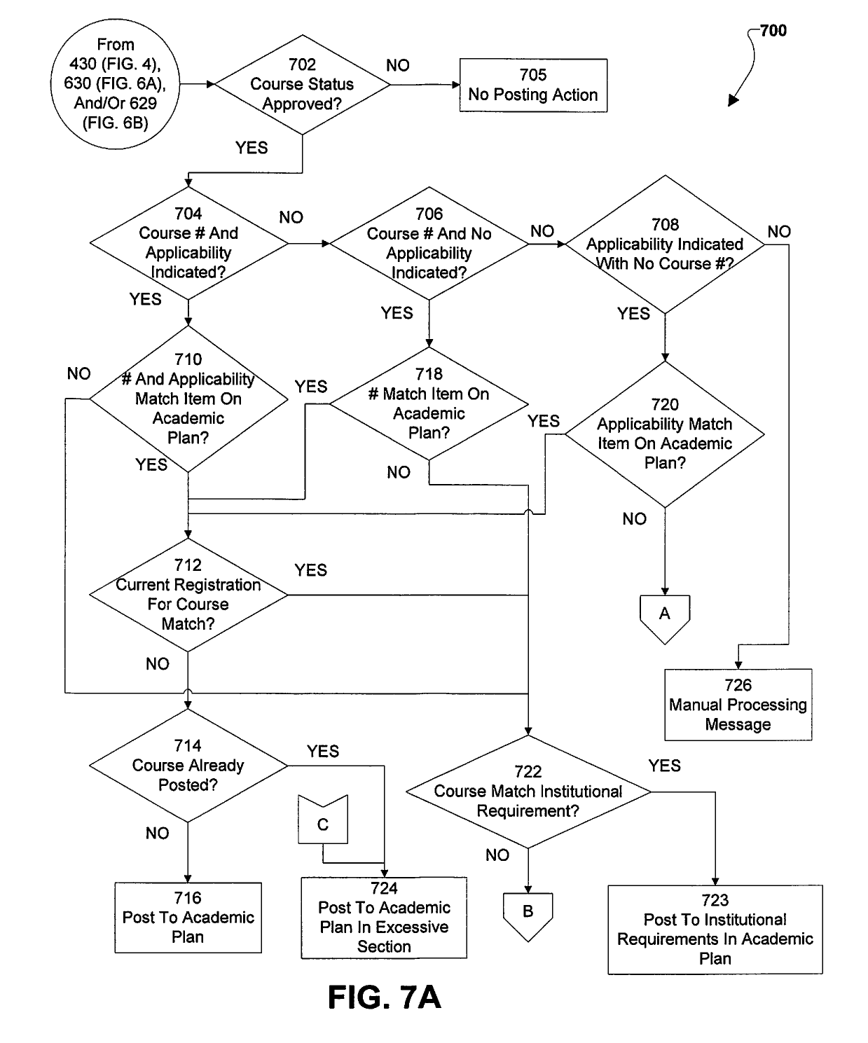

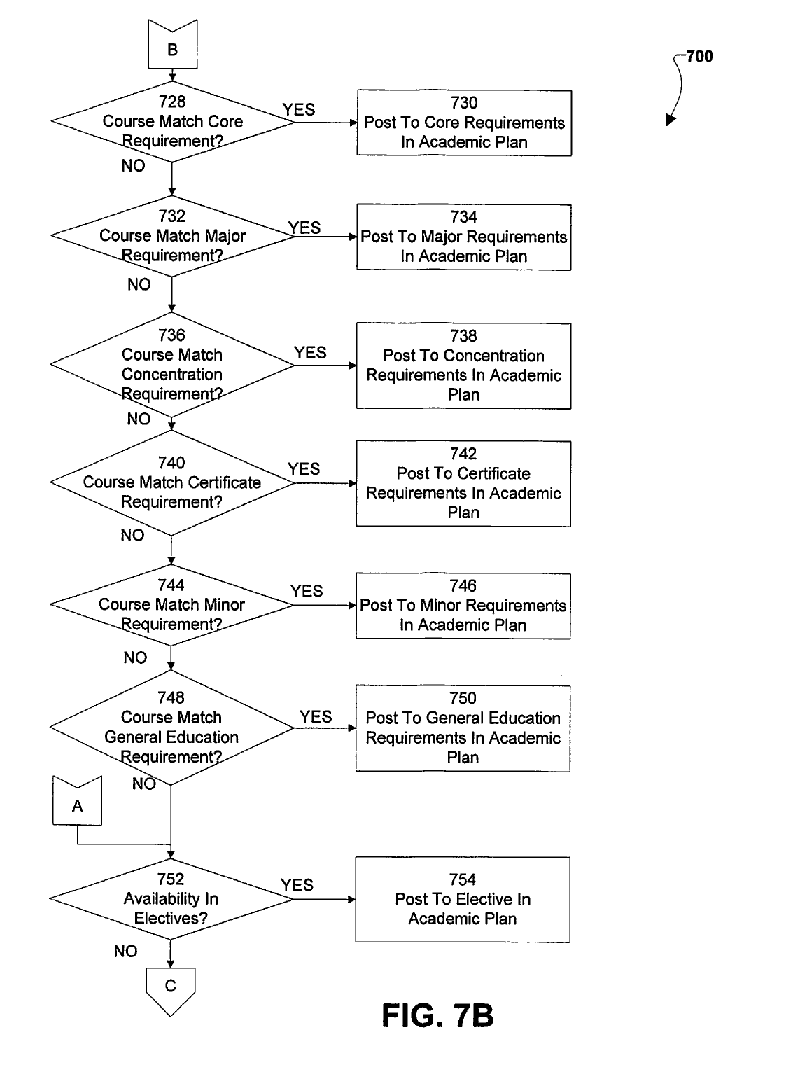

FIGS. 7A and 7B are flow diagrams illustrating a credit posting process 700 for posting granted credits to a student's academic plan according to an embodiment. In an embodiment, the operations of process 700 may be performed by a processor of a computing device, such as a personal computer or server. The process 700 may provide a rules engine for posting credits to a student's academic plan. Referring to FIG. 7A, in an embodiment, the operations of process 700 may be performed after credit is granted to the student in blocks 430 of FIG. 4, 630 of FIG. 6A, and/or 629 of FIG. 6B. After granting credit, in block 702 the status of the course as approved may be determined. If the course was not approved (i.e., determination block 702=“No”), no posting action will be taken in block 705. If the course was approved (i.e., determination block 702=“Yes”), in block 704 the processor may determine whether the course number and applicability for the course are indicated. Applicability may be a category assigned to the course indicating how the course may apply to an academic plan. For example, applicability categories may indicate the course is an institutional requirement, general education requirement, specific discipline requirement (e.g., English, Humanities, History, Literature, Mathematics, Political Science, Science, Social Science, etc.), a core requirement, a major requirement, a final program requirement, a general elective, etc. Applicabilities may be given relative rankings such that certain requirements will be filed or applied before others. For example, institutional requirements may be applied before electives. If the course number and applicability are not indicated (i.e., determination block 704=“No”), in block 706 the processor may determine if the course number and no applicability are indicated. If the course number and no applicability are not indicated (i.e., determination block 706=“No”), in block 708 the processor may determine if the applicability and no course number are indicated. If the applicability and no course number are not indicated (i.e., determination block 708=“No”), a manual processing message may be displayed in block 726.

If the course number and applicability are indicated (i.e., determination block 704=“Yes”), in block 710 the processor may determine whether the course number and applicability match an item on the academic plan for the student. If the course number and no applicability are indicated (i.e., determination block 706=“Yes”), in block 718 the processor may determine whether the course number matches an item on the academic plan. If the applicability and no course number are indicated (i.e., determination block 708=“Yes”), the processor may determine whether the applicability matches an item on the academic plan in block 720. If blocks 710, 718, or 720 equal “Yes”, the processor may determine whether a current registration for a course matches the course number in block 712. If the course does not match a current registration (i.e., determination block 712=“No”), in block 714 the processor may determine whether the course is already posted. If the course is already posted (i.e., determination block 714=“Yes”), the processor may post the credit to the academic plan in an excessive section in block 724. If the course is not already posted (i.e., determination block 714=“No”), the processor may post the credit to the academic plan.

If the course number and applicability do not match an item on the academic plan (i.e., determination block 710=“No”), the course number does not match an item on the academic plan (i.e., determination block 718=“No”), or a current registration for the course does match (i.e., determination block 712=“Yes”), in block 722 the processor may determine whether the course matches an institutional requirement for the student. If the course matches (i.e., determination block 722=“Yes”), the processor may post the course to the institutional requirements in the student's academic plan in block 723.

If the course does not match (i.e., determination block 722=“No”), in block 728 (FIG. 7B) the processor may determine whether the course matches a core requirement for the student. If the course matches (i.e., determination block 728=“Yes”), the processor may post the course to the core requirements in the student's academic plan in block 730.

If the course does not match (i.e., determination block 728=“No”), in block 732 the processor may determine whether the course matches a major requirement for the student. If the course matches (i.e., determination block 732=“Yes”), the processor may post the course to the major requirements in the student's academic plan in block 734.

If the course does not match (i.e., determination block 732=“No”), in block 736 the processor may determine whether the course matches a concentration requirement for the student. If the course matches (i.e., determination block 736=“Yes”), the processor may post the course to the concentration requirements in the student's academic plan in block 738.

If the course does not match (i.e., determination block 736=“No”), in block 740 the processor may determine whether the course matches a certificate requirement for the student. If the course matches (i.e., determination block 740=“Yes”), the processor may post the course to the certificate requirements in the student's academic plan in block 742.

If the course does not match (i.e., determination block 740=“No”), in block 744 the processor may determine whether the course matches a minor requirement for the student. If the course matches (i.e., determination block 744=“Yes”), the processor may post the course to the minor requirements in the student's academic plan in block 746.

If the course does not match (i.e., determination block 744=“No”), in block 748 the processor may determine whether the course matches a general education requirement for the student. If the course matches (i.e., determination block 748=“Yes”), the processor may post the course to the general education requirements in the student's academic plan in block 750.

If the applicability matches an item on the academic plan (i.e., determination block 720 (FIG. 7A)=“Yes”) or the course does not match (i.e., determination block 748 (FIG. 7B=“No”), in block 752 the processor may determine whether there is an availability for the course in an electives section for the student. If there is availability in electives (i.e., determination block 754=“Yes”, the processor may post the course as an elective in the student's academic plan. If there is no availability (i.e., determination block 754=“No”), the processor may post the credit to the academic plan in an excessive section in block 724 (FIG. 7A).

The operations of blocks 716, 722, 723, 724, 728, 730, 732, 734, 736, 738, 740, 742, 744, 746, 748, 750, 752, and 754 to post granted credits to a student's academic plan may post the credits based at least in part on the relative relationship of the applicabilites of the granted credits and the applicability relative to the student's academic plan. While blocks 716, 722, 723, 724, 728, 730, 732, 734, 736, 738, 740, 742, 744, 746, 748, 750, 752, and 754 are illustrated as occurring in a relative order, the order of the blocks is only one example of a process for posting granted credits, and the order of the blocks may be change based on the applicability and/or the individual requirements of any specific student's academic plan.

In the various embodiments, the transfer credit evaluation process 104, the test score credit evaluation process 110, and/or the military transcript credit evaluation process 110 may enable credit evaluations to be made at a pace and with an accuracy that could not be achieved by human operation alone. For example, the various processes 104 and/or 110 may enable 24,718 transfer credit records or files to be evaluated in an average of 4.77 days with a first pass yield of 95.55 percent.

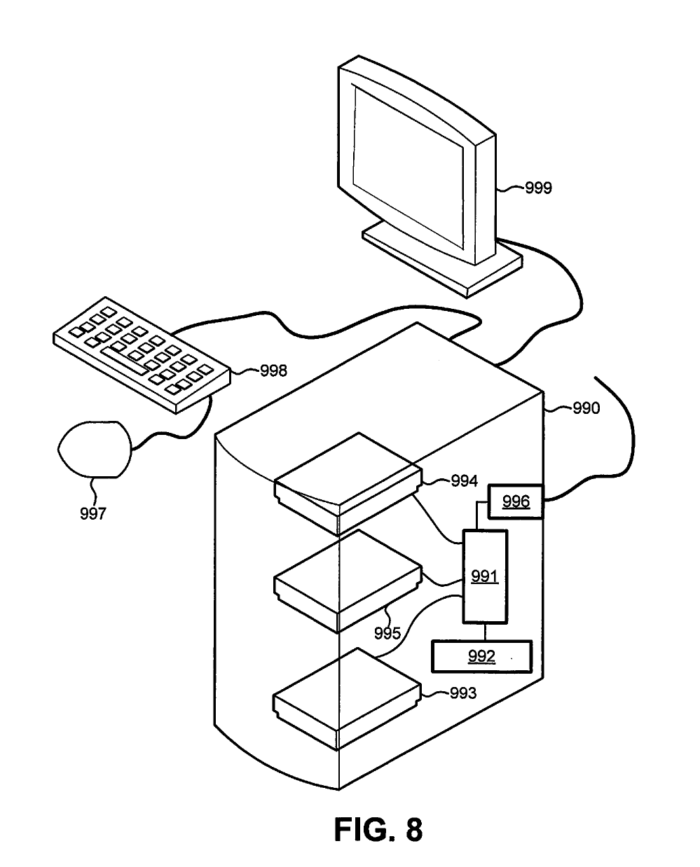

The various determinations, computations and operations illustrated in FIGS. 1-7B and described above may be performed using a processor executing software instructions. For example, the processor of a personal computer may be used for this purpose. By way of illustration, the functional components of a personal computer 990 are illustrated in FIG. 8. Such a personal computer 990 typically includes a processor 991 coupled to volatile memory 992 and a large capacity nonvolatile memory, such as a disk drive 993. The computer 990 may also include a floppy disc drive 994 and a compact disc (CD) drive 995 coupled to the processor 991. Typically the computer device 990 will also include a pointing device such as a mouse 997, a user input device such as a keyboard 998 and a display 999. The computer device 990 may also include a number of connector ports coupled to the processor 991 for establishing data connections or receiving external memory devices, such as USB or FireWire® connector sockets or other network connection circuits 996 for coupling the processor 991 to a network. The computer housing may include the pointing device 997, keyboard 998 and the display 999 as is well known in the computer arts.

The personal computer may be configured as a desktop computer, a laptop computer, a tablet or a smart phone. The functions described above may be performed using a personal computer having some or all of the functional components of personal computer 990.

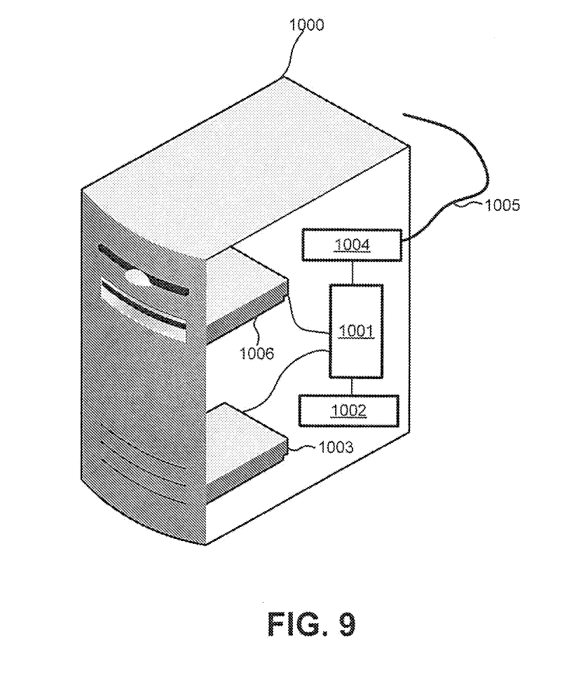

A number of the aspects described above may also be implemented with any of a variety of remote server devices, such as the server 1000 illustrated in FIG. 9. Such a server 1000 typically includes a processor 1001 coupled to volatile memory 1002 and a large capacity nonvolatile memory, such as a disk drive 1003. The server 1000 may also include a floppy disk drive and/or a compact disc (CD) drive 1006 coupled to the processor 1001. The server 1000 may also include a number of connector ports 1004 coupled to the processor 1001 for establishing data connections with network circuits 1005. When used herein, the term “server” refers to a hardware device unless otherwise stated.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory computer-readable medium. The steps of a method or algorithm disclosed herein may be embodied in a processor-executable software module which may reside on a computer-readable medium. Non-transitory computer-readable media include both computer storage media and communication media including any medium that facilitates transfer of a computer program from one place to another. Storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A method for granting course credits at a first educational institution, the method comprising:
receiving, in a processor, a transcript of a student in a first format from a second educational institution;
converting, in the processor, the transcript from the first format to a second format to obtain transcript data, wherein at least the transcript data in the second format is machine readable;
capturing, in the processor, course identifying information from the transcript data;
comparing, in the processor, the course identifying information in the transcript data to course identifying information stored in a datastore; and
determining, in the processor, that a course taken by the student at the second educational institution is eligible for credit when the course identifying information for that course in the transcript data matches at least in part course identifying information stored in the datastore.

2. The method of claim 1, wherein the course identifying information is selected from the group consisting of course name, course prefix, course number, course title, date completed, grade earned, hours earned, and date taken.

3. The method of claim 1, further comprising:
comparing, in the processor, credit criteria to the transcript data when the course is eligible for credit; and
granting to the student a credit for the course when the credit criteria are met by the transcript data.

4. The method of claim 3, wherein the credit criteria are selected from the group consisting of course name, course prefix, course number, course title, date completed, grade earned, hours earned, date taken and other information that identifies the course taken, course prefix, course number, course title, date completed, key words and learning outcomes.

5. The method of claim 3, further comprising posting the granted credit for the course to the student's academic plan based at least in part on an applicability category of the course.

6. The method of claim 1, further comprising:
determining, in the processor, whether an agreement has been reached between the first educational institution and the second educational institution to grant credit for particular courses associated with the second educational institution;
determining, in the processor, whether the transcript data of the student indicates that the student has received a degree from the second educational institution when the agreement has been reached between the first educational institution and the second educational institution; and
granting to the student credits for the particular courses associated with the degree when the transcript data of the student indicates that the student has received a degree from the second educational institution.

7. The method of claim 1, wherein the transcript of a student comprises a military transcript and the second educational institution comprises a military organization.

8. A system for granting course credits at a first educational institution, comprising:
a datastore; and
a processor connected to the datastore, wherein the processor is configured with processor-executable instructions to perform operations comprising:
receiving a transcript of a student in a first format from a second educational institution;
converting the transcript from the first format to a second format to obtain transcript data, wherein at least the transcript data in the second format is machine readable;
capturing course identifying information from the transcript data;
comparing the course identifying information in the transcript data to course identifying information stored in the datastore; and
determining that a course taken by the student at the second educational institution is eligible for credit when the course identifying information for that course in the transcript data matches at least in part course identifying information stored in the datastore.

9. The system of claim 8, wherein the course identifying information is selected from the group consisting of course name, course prefix, course number, course title, date completed, grade earned, hours earned, and date taken.

10. The system of claim 8, wherein the processor is configured with processor-executable instructions to perform operations further comprising:
comparing credit criteria to the transcript data when the course is eligible for credit; and
granting to the student a credit for the course when the credit criteria are met by the transcript data.

11. The system of claim 10, wherein the credit criteria are selected from the group consisting of course name, course prefix, course number, course title, date completed, grade earned, hours earned, date taken and other information that identifies the course taken, a course prefix, a course number, a course title, date completed, key words and learning outcomes.

12. The system of claim 10, wherein the processor is configured with processor-executable instructions to perform operations further comprising posting the granted credit for the course to the student's academic plan based at least in part on an applicability category of the course.

13. The system of claim 8, further comprising:
determining whether an agreement has been reached between the first educational institution and the second educational institution to grant credit for particular courses associated with the second educational institution;
determining whether the transcript data of the student indicates that the student has received a degree from the second educational institution when the agreement has been reached between the first educational institution and the second educational institution; and
granting to the student credits for the particular courses associated with the degree when the transcript data of the student indicates that the student has received a degree from the second educational institution.

14. The system of claim 8, wherein the transcript of a student comprises a military transcript and the second educational institution comprises a military organization.

15. A non-transitory processor readable medium having stored thereon processor-executable instructions configured to cause a processor to perform operations for granting course credits at a first educational institution, comprising:
receiving a transcript of a student in a first format from a second educational institution;
converting the transcript from the first format to a second format to obtain transcript data, wherein at least the transcript data in the second format is machine readable;
capturing course identifying information from the transcript data;
comparing the course identifying information in the transcript data to course identifying information stored in a datastore; and
determining that a course taken by the student at the second educational institution is eligible for credit when the course identifying information for that course in the transcript data matches at least in part course identifying information stored in the datastore.

16. The non-transitory processor readable medium of claim 15, wherein the store processor-executable instructions are configured to cause a processor to perform operations such that the course identifying information is selected from the group consisting of course name, course prefix, course number, course title, date completed, grade earned, hours earned, and date taken.

17. The non-transitory processor readable medium of claim 15, wherein the store processor-executable instructions are configured to cause a processor to perform operations further comprising:
comparing credit criteria to the transcript data when the course is eligible for credit; and
granting to the student a credit for the course when the credit criteria are met by the transcript data.

18. The non-transitory processor readable medium of claim 17, wherein the store processor-executable instructions are configured to cause a processor to perform operations such that the credit criteria are selected from the group consisting of course name, course prefix, course number, course title, date completed, grade earned, hours earned, date taken and other information that identifies the course taken, a course prefix, a course number, a course title, date completed, key words and learning outcomes.

19. The non-transitory processor readable medium of claim 17, wherein the store processor-executable instructions are configured to cause a processor to perform operations further comprising further comprising posting the granted credit for the course to the student's academic plan based at least in part on an applicability category of the course

20. The non-transitory processor readable medium of claim 15, wherein the store processor-executable instructions are configured to cause a processor to perform operations further comprising:
determining whether an agreement has been reached between the first educational institution and the second educational institution to grant credit for particular courses associated with the second educational institution;
determining whether the transcript data of the student indicates that the student has received a degree from the second educational institution when the agreement has been reached between the first educational institution and the second educational institution; and
granting to the student credits for the particular courses associated with the degree when the transcript data of the student indicates that the student has received a degree from the second educational institution.

21. The non-transitory processor readable medium of claim 15, wherein the transcript of a student comprises a military transcript and the second educational institution comprises a military organization.
